(19) United States
(12) Patent Application Publication
(10) Pub. No.: US 2011/0108701 A1
(43) Pub. Date: May 12, 2011

(54) Apparatus for Making Windows And Shafts In Concrete Slabs

(76) Inventor: Daniel Heeren, Dell Rapids, SD (US)

(21) Appl. No.: 12/942,009

(22) Filed: Nov. 8, 2010

Related U.S. Application Data
(60) Provisional application No. 61/259,626, filed on Nov. 9, 2009.

(51) Int. Cl. B28B 7/00

(52) U.S. Cl. 249/13

(57) ABSTRACT

A form for use when casting a concrete slab with an opening for a window or a shaft. The form has corner members and intermediate members. Each corner member has two vertical members positioned end to end to form an angle. A first end plate is attached to an end of the corner member, and a second end plate is attached to the other end of the corner member. The first and second end plates form an angle with the vertical members wherein the angle of any one corner member, when added to all the corner angles in a complete form equals 360 degrees.

### REFERENCE TO RELATED APPLICATIONS

This patent application claims the benefit of U.S. Provisional Application No. 61/259,626 filed on Nov. 9, 2009, the disclosure of which is incorporated herein in its entirety by reference.

### BACKGROUND OF THE INVENTION

1. Field of the Invention

The present invention relates generally to an adjustable form for pouring concrete and more specifically to an adjustable form that can be more readily and easily removed after the concrete hardens. The adjustable form has truncated wedge shaped corner and intermediate members which allow the form members to be easily removed after the cement hardens. The forms disclosed can be used to produce a window or a shaft having straight sides and right angle corners in a concrete slab.

2. Description of Related Art

Forms for making windows and shafts in concrete slabs having thicknesses of four inches or more have traditionally been made of wood planks that are placed on edge and held in place with wood stakes which may be driven into the ground and nailed or screwed to the wood planks. A disadvantage of using wood planks and stakes is the time and labor required to cut the planks to size and assemble the form. After the concrete hardens, the wood stakes and planks are removed. The wood planks must be either cut or increased in length for use on the next job and the stakes that were destroyed must be replaced. Normally, the life span of wood planks and stakes which are constantly used in setting up a form, holding the concrete in place until it hardens, and then taking down the form is limited and the wood must constantly be replaced.

To reduce the cost associated with wood forms for concrete slabs, builders use forms that are made of more durable material such as steel aluminum or other metal where the metal form can be a square C shaped channel and where the web and flanges of the C channel can vary from one-eighth of an inch or less to about one-half of an inch or more in thickness. This thickness is required to prevent the various metal members of the form from deflecting as concrete is poured into the form However, as metal is more durable than wood, a disadvantage is that metal does not bend and, therefore, when the concrete is hard, the metal form can be locked in place and be difficult to remove. Another disadvantage is that metal forms cannot be readily cut to size and, therefore, must be made up of different size members which are attached to each other with a threaded bolt and nut or a key such as a bolt having a shaft with a slot that is placed in aligned holes of adjacent members and a metal wedge is then hammered into the slot in the bolt shaft to tie and pull adjacent members together.

What is needed is a reusable form that can be used to make windows and down shafts in a concrete slab and can be easily removed after a concrete slab hardens.

### SUMMARY OF THE INVENTION

In an exemplary embodiment of the present invention, there is disclosed a form for use when casting a concrete slab with an opening for a window or a down shaft having at least one corner member and one intermediate member wherein said corner member comprises:

first and second vertical webs positioned end to end to form an angle;

first and second top flanges attached to the top of said first and second vertical webs;

first and second bottom flanges attached to the bottom of said first and second vertical webs;

a first end plate attached to an end of said first web, an end of said first top flange, and an end of said first bottom flange; and

a second end plate attached to an end of said second web, an end of said second top flange, and an end of said second bottom flange;

wherein said first end plate forms an angle with the first vertical web, and said second end plate forms an angle with the second vertical web wherein the angle of said at least on corner member, when added to all the corners in a complete form equals 360 degrees.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a partial perspective view of a concrete form having metal members for providing windows and down shafts in concrete slabs and where the form can be easily removed after poured concrete hardens in accordance with the principles of the invention;

FIG. 2 is a partial perspective view of the concrete contacting surface of the concrete form of FIG. 1; and

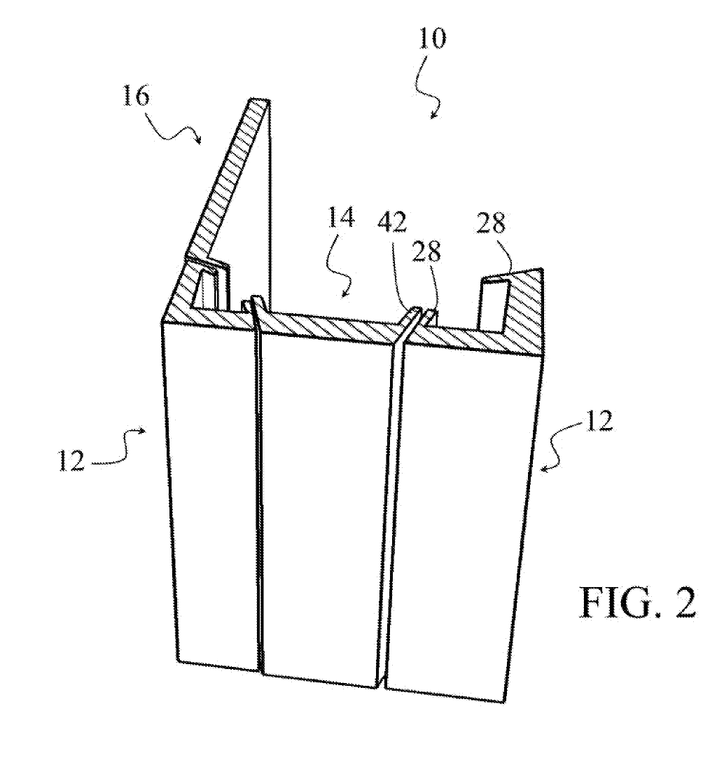

FIG. 3 is a plan view of a wood beam attached to a coupling member of a side plate and an end plate which can be used in place of a metal intermediate metal member for providing a window or a down shaft in a concrete slab where the various members of the form can be easily removed after poured concrete hardens in accordance with the principles of the invention.

### DESCRIPTION OF THE PREFERRED EMBODIMENT

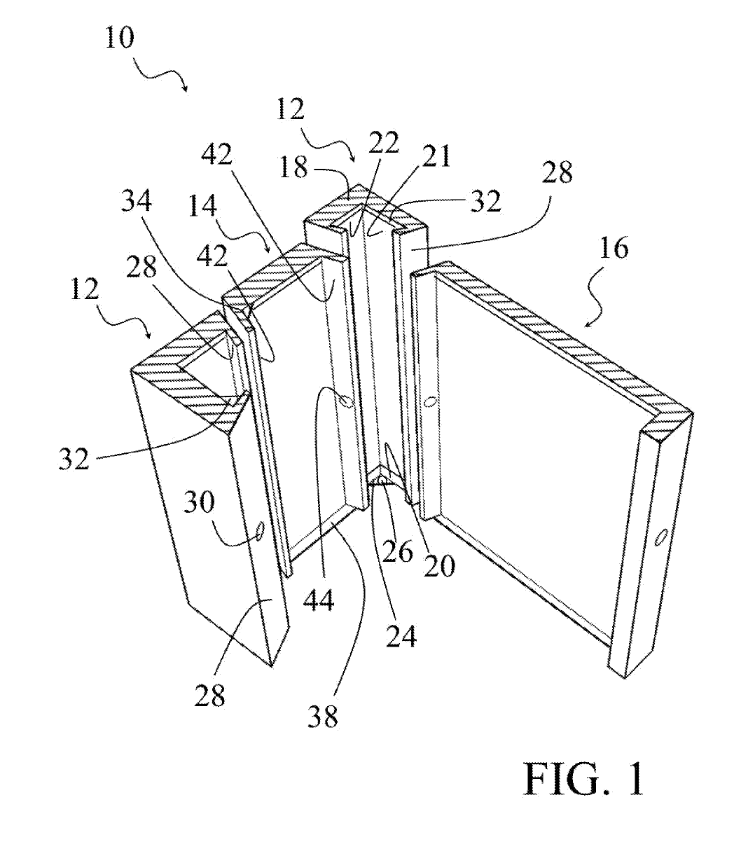

Referring to FIG. 1, there is shown a partial perspective view of a concrete form having metal members for providing windows and down shafts in concrete slabs and where the form can be easily removed after poured concrete hardens in accordance with the principles of the invention To prepare the concrete form, a plurality of corner members and a plurality of intermediate straight members are assembled to form a desired shape such as, for example, a square or a rectangle In the embodiment here disclosed the concrete form is a rectangle for providing an opening in a poured concrete floor of six inches in thickness in a high rise building where the opening can be for an elevator shaft or a stair way. The form has identical corner members that can be reused and intermediate members which can be of different lengths.

In FIG. 1, the partially completed formwork 10 has two identical corner members 12, a short intermediate member 14, and a longer intermediate member 16. For a complete form, all of the form corners are identical and can be reused. Corner member 12 is composed of aluminum, iron, steel or fiberglass having two vertical web members 21, 22 joined together at one of their edges to form any angle. In the embodiment disclosed the angle is a right angle. An inwardly projecting top flange 18 is attached to the top edge of the vertical members 21, 22, and an inwardly projecting bottom flange is attached to the bottom of the vertical members. Inwardly projecting end plates are attached to the ends of the vertical members.

Depending on the material used, the top flange 18, bottom flange 20, and center web 22 can be from one-quarter of an inch more or less up to one inch in thickness. A corner plate 24 of the same thickness as the bottom flange 20 is welded to the two bottom flanges of the corner member. Corner plate 24 has an opening 26 of three quarter of an inch or larger for receiving an anchoring pin, not shown. An anchoring pin can be rail way spike or the like which can be placed through the opening 26 and hammered into a subfloor to lock the corner member of the framework to a desired position. Thus, the anchoring pin is used to prevent the formwork from shifting while cement is being poured and hardens.

Each end plate 28 of the corner member made can have a thickness from one-eighth of an inch more or less up to one half of an inch more or less. The corner member can be cast as a single piece or the various parts can be welded together. Each end plate 28 has an opening 30 for receiving a key or coupling pin that is used to draw together and hold an intermediate member to the corner member. Each end plate 28 on the corner member forms an angle 32 of between 45 degrees and 95 degrees, more or less, with the center webs 21, 22. The corner member 12 shown in FIG. 1 is for making openings in six inch thick concrete slabs and, therefore, they have a height of about six inches. It is understood that the corner member can have a height that is the height of the concrete for making openings in slabs.

Intermediate member 14 has a cross section that is similar to the cross section of corner member 12. Intermediate member has a top flange 36, a bottom flange 38, and a vertical web 40. Intermediate member 14 has an end plate 42 at each end which forms an angle 34 of between 135 degrees and 85 degrees with the web 40. The angle that the end plate forms with the vertical web, when added to the angle that an end plate of an adjacent corner member forms with its web, should equal 180 degrees. Thus, when the intermediate member is placed against and attached to the corner member, the intermediate member and the corner member will form a straight line. End plates of the Intermediate have openings 44 that are aligned with the openings 30 in the corner member end plates for receiving locking pins or keys well known by those familiar with assembling concrete formwork. Intermediate member 16 is similar to intermediate member 14 in all aspects but for their lengths, and can be made by welding the various parts together or by being cast. Intermediate members can be made of aluminum, iron, steel or fiberglass.

When being used, a rectangle having four corner members 12 two intermediate members 14 and two intermediate members 16 are assembled to form an opening that is either a rectangle or a square, and concrete is poured around the outside perimeter of the form. It is understood that the corner members are not limited to having 90 degree angles, but can have angles that are other than 90 degrees. Subsequently, the concrete hardens and the form must be removed. Locking pins or keys which are used to lock intermediate members 14 to the corner members 12 are removed to allow the form to be taken apart. Now, looking at the end of the form, it can be seen that intermediate member 14 is wedged shaped relative to end members 12 and, therefore, can be easily removed from between the two angled members. After the locking pins or keys are removed, the intermediate member can be easily removed from between the two corner members by using a pry bar that is placed between the hard concrete and the intermediate member to release the intermediate member from the concrete. Once the intermediate member is released from the concrete, it can be easily pulled into the open window area. This procedure is repeated for each side of the form. After the intermediate members are removed, the corner members can be easily and quickly removed from the hard concrete.

The above embodiment is for providing an opening in a concrete slab. It is understood that the corner members and intermediate members can be fabricated to provide formwork that can be used to make slabs as opposed to providing openings in slabs.

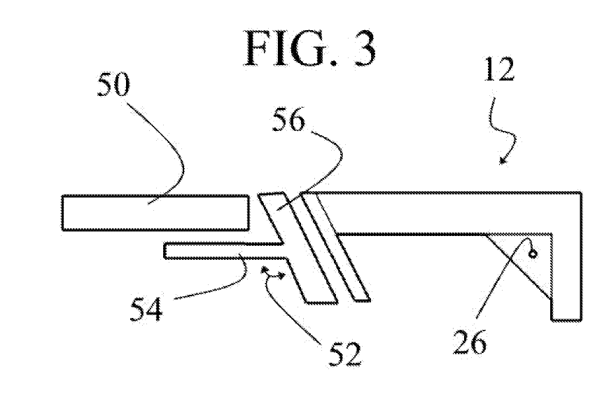

In some instances the formwork that is being assembled is of a size for which there is no metal intermediate member. In this instance, a wood beam having a thickness of about two inches, more or less, which has been cut to length is attached to a coupling member. Referring to FIG. 3, wood beam 50 which can have a thickness of about two inches more of less is securely attached to a vertical side plate 54. A vertical end plate 56 is securely attached to the side plate 54. The end plate 56 forms an angle with the side plate 54 which, when added to the angle that an end plate of an adjacent corner member forms with its web, equals 180 degrees. Coupling member can be made of aluminum, iron or steel, and can be made by welding the two members together or by caxting. The coupling member has an opening that is aligned with the opening 30 in the corner member for receiving a locking pin or a key. In all other aspects the wood beam and the coupling member functions as if it is a metal intermediate member.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A form for use when casting a concrete slab with an opening for a window or a down shaft having at least one corner member and one intermediate member wherein said corner member comprises:
first and second vertical members positioned end to end to form an angle;
a first end plate attached to an end of said first member; and
a second end plate attached to an end of said second member;
wherein said first end plate forms an angle with the first vertical member, and said second end plate forms an angle with the second vertical member; wherein the angle of said at least one corner member, when added to all the corner angles in a complete form equals 360 degrees.

2. The form of claim 1 wherein said angle formed by said first end plate and said first member is less than 90 degrees, and said angle formed by said second end plate and said second member is less than 90 degrees.

3. The form of claim 2 wherein said angle formed by said first end plate and said first member is less than 90 degrees, and said angle formed by said second end plate and said second member is less than 90 degrees.

4. The form of claim 1 wherein a corner plate is attached to the first member and the second member.

5. The form of claim 1 wherein said first and second end plates of said corner member each have an opening for receiving a member for drawing together and holding an intermediate member to the corner member.

6. The form of claim 1 wherein said intermediate member comprises:
a structural member;
a member attached to the structural member;
a first end plate attached to a first end of said member and a first end of said structural member; and
a second end plate attached to a second end of said member and a second end of said structural member;
wherein said first end plate forms an angle with the vertical member which, when added to the angle that an end plate of an adjacent corner member forms with its member, equals 180 degrees, and said second end plate forms an angle with the vertical member which, when added to the angle that an end plate of an adjacent corner member forms with its member, equals 180 degrees.

7. The form of claim 6 wherein said first and second end plates of said intermediate member each have an opening for receiving a key for drawing together and holding a corner member to the intermediate member.

8. The form of claim 1 wherein said intermediate member comprises:
a coupling member of durable material having a vertical side plate adapted to be attached to a side of a wood plank, and an end plate attached to an edge of said side plate; wherein said end plate forms an angle with the vertical side plate which, when added to the angle that an end plate of an adjacent corner member forms with its member, equals 180 degrees.

9. The form of claim 8 wherein said vertical side plate and said end plate are made aluminum, iron, steel or any durable material.

10. The form of claim 9 wherein said end plate has an opening for receiving a key for holding said intermediate member to a corner member.

11. The form of claim 1 wherein said corner member is made of aluminum, iron, steel or any durable material.

12. The form of claim 6 wherein the first and second end plates of said intermediate member are angled to allow easy removal from between two corner members after a slab of concrete located around the form hardens.
